(19) United States
(12) Patent Application Publication
(10) Pub. No.: US 2005/0214718 A1
(43) Pub. Date: Sep. 29, 2005

(54) Dental ceramic adhesion promoter

(76) Inventors: Karsten Rettig, Feldkirch (AT); Klaus Kleboth, Innsbruck (AT); Oliver Heinzle, Gotzis (AT)

Correspondence Address: BACHMAN & LAPOINTE, P.C., 900 CHAPEL STREET, SUITE 1201, NEW HAVEN, CT, 06510, US

(21) Appl. No.: 11/085,667

(22) Filed: Mar. 21, 2005

(30) Foreign Application Priority Data
Mar. 23, 2004 (DE) 10 2004 014 604.7

(51) Int. Cl. A61C 13/09

(52) U.S. Cl. 433/208

(57) ABSTRACT

A dental ceramic adhesion promoter for binding a metal base structure (2), formed in particular by a non-precious metal alloy, to a dental ceramic layer (3, 4, 5) which is to be applied, wherein the adhesion promoter (1) comprises an adhesion promoter material comprising between 10 and 50% by weight, in particular between 30 and 45%, of titanium dioxide and/or tin dioxide, between 3 and 30% by weight of boron trioxide, and a glass component.

### BACKGROUND OF THE INVENTION

The present invention relates to a dental ceramic adhesion promoter for bonding a metal base structure to a dental ceramic layer.

Such adhesion promoters are known in a general manner from the prior art and are usually used, as shown by way of example in FIG. 1, to establish better adhesion between a metal structure 2 (for example a dental bridge) and a ceramic layer 3 which is to be applied thereto; in the illustrated example of embodiment, a so-called opaquer layer 3 is seated on the adhesion promoter layer 1, which opaquer layer in turn bears a dentin layer 4 and also an enamel material 5 thereon.

In this case, the metal substrate used for the metal structure may be either a precious metal or precious metal alloy (typically, besides gold, also platinum, palladium, silver) or alternatively a non-precious metal alloy, preferably comprising chromium, cobalt, nickel, molybdenum, tungsten, vanadium, niobium or silicon.

Here, with regard to permanent binding between such a metal alloy of the base structure and a dental ceramic, the physical and/or chemical adhesion of the ceramic material to the metal is critical, and this in turn is critically influenced by the respective thermal expansion coefficient (hereinafter: TEC). In other words, a thermal expansion which is as compatible as possible and substantially identical is desirable for permanent and durable binding.

From the prior art knowledge regarding the creation of the bond between the dental ceramic layer and the underlying metal base structure, it is known that, besides mechanical retention of the ceramic on surface roughnesses and undercuts of the metal, by suitably selecting the thermal expansion coefficients of ceramic and metal the ceramic is put under compressive stress during the cooling process of the ceramic firing operation. This leads, in the cooling phase of the ceramic firing operation, to shrinking of the ceramic onto the metal body and to the compression of microcracks in the ceramic, with the advantageous effect that the ceramic, in the event of mechanical stress, is placed under a damaging tensile stress only at a late stage. The mechanical adhesion brought about by surface roughnesses and undercuts is also improved; therefore, the adhesion strength of the ceramic coating on the metal base structure is also increased thereby.

However, chemical binding forces also play a significant role in efficient metal/ceramic binding.

In general, in order to achieve better adhesion, use is made of an adhesion promoter (known as a bonder) which is applied or fired on as a thin layer between the metal substrate (base structure) and the dental ceramic. These bonders have the function of improving the chemical adhesion.

From the prior art, numerous adhesion promoters are known which are said to improve the adhesion between metal structure and ceramic. For example, DE 43 211 00 describes a ceramic with added fine tin powder which, as a reducing agent, prevents the discoloration phenomena which occur in the case of copper-containing metal structures. Furthermore, DE 100 22 559 discloses a composite material which, besides a ceramic component, also comprises as an important main constituent a metal powder mixture of fine gold and/or a refractory metal oxide.

DE 30 46 334 describes an adhesion promoter which, besides a flux, also comprises gold, silver and a high-melting non-precious alloy, and finally DE 25 25 274 describes an adhesion promoter which consists of gold particles, a porcelain material, zirconium dioxide and boron oxides, and is applied to or fired onto the metal structure as a suspension.

However, one common feature of all these known adhesion promoters is that they often have poor adhesion properties in the critical transition region between non-precious-metal-containing base structure and the overlying dental ceramic, not least on account of the unsatisfactorily resolved differences in the TEC of the materials to be bonded.

In order to adapt the thermal expansion coefficients of metal alloy and ceramic to one another, special metal alloys (known as fusion alloys and/or ceramics) have been developed, the TECs of which are adapted to one another in such a way that they exhibit an identical or similar expansion behavior. The stresses (fractures, cracks or chipping of the ceramic from the metal structure) which are caused by different expansion of the materials are thus effectively avoided. However, since in principle a special, TEC-compatible ceramic must be available as a counterpart for each metal alloy, such a solution is not very practical.

In particular, since, in respect of dental ceramic layers on precious-metal-free metal base structures, there is the desire to improve the chemical adhesion but at the same time to combine metal alloys and ceramics having different expansion behaviors with one another, there is a great need for adhesion promoters which are able to act, in terms of their expansion behavior, as a mechanical buffer between the (in particular precious-metal-free) surface of the metal base structure and the dental ceramic layer which is to be applied.

It is therefore an object of the present invention to provide an improved adhesion promoter for binding a metal, in particular precious-metal-free, base structure to a dental ceramic layer, which adhesion promoter has a high adhesion effect and is suitable for attenuating mechanical stresses between base structure and dental ceramic layer which are caused by different thermal stresses.

### SUMMARY OF THE INVENTION

The foregoing object is achieved by the dental ceramic adhesion promoter between 10 to 50% by wt. at least one of titanium dioxide and tin dioxide, between 3 to 30% by wt. boron trioxide, and a glass component. Further provided is a method of producing a dental prosthesis comprising preparing an aqueous or alcoholic slip of the adhesion promoter, applying the slip to a metal base structure, firing the applied slips, and applying a further dental layer to the fired slip coating.

### BRIEF DESCRIPTION OF THE DRAWING

FIG. 1 is a dental restoration structure of the prior art.

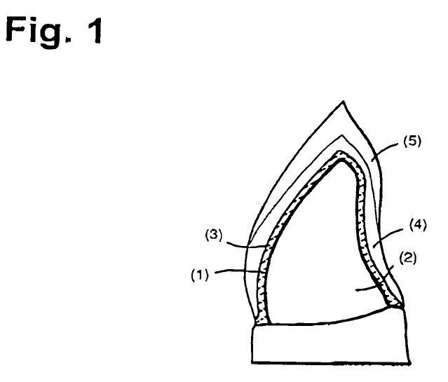

### DETAILED DESCRIPTION

In an advantageous manner according to the invention, the dental ceramic adhesion promoter of the invention is formed by an adhesion promoter material (which is to be understood here as a starting product for application to the base structure prior to a firing operation) which, besides the typical glass-forming oxides, SiO₂, (referred to in the context of the invention as “glass component”), comprises boron trioxide in a range of between 3 and 30% by weight and a metal dioxide in the form of titanium dioxide and/or tin dioxide in a range of between 10 and 50% by weight, wherein it has been found to be particularly preferable here to provide the metal dioxide component in a proportion of between 30 and 45% by weight of the adhesion promoter material.

According to the invention, it has specifically proven to be advantageous that, although boron trioxide on its own is obviously unable to act as an effective adhesion promoter in the present context, in conjunction with the metal oxides used according to the invention it appears to form a network by virtue of oxide bridges, which network (since the surfaces are usually covered by a strongly adhering oxide layer even in the case of non-precious metals) leads to a strongly adhering coat once fired at a temperature of between 950 to 1000° C. If, as in the context of the present invention, boron trioxide is used together with a glass (or as a constituent of this glass), it must be assumed that there is a mechanically effective bridge function as a chemical bond to the metal surface; if, as can usually be implemented in a simple manner, the TEC of the dental ceramic layer which according to the invention is applied to the adhesion promoter is designed to substantially correspond to veneer ceramics to be applied thereto, an extremely strong adhesion of the overall arrangement is to be expected.

In particular, within the context of the invention, the addition of metal dioxide, in particular titanium dioxide, in relatively high amounts seems to act as a TEC buffer so that, within the context of the invention, the combination of the three components—boron trioxide, metal dioxide and glass—results in a universal and extremely effective adhesion promoter, in particular for binding precious-metal-free alloys to veneer ceramics.

When implementing the invention in practice, it has proven to be particularly preferable to provide Al₂O₃ as a constituent of the glass component in an amount of between 5 and 20 weight %, and even more preferable to add K₂O and/or Na₂O each in an amount of up to 20 weight %. It is also advantageous to provide CaO in an amount of up to 5 weight % as a constituent of the glass component and/or to provide the boron trioxide used in the adhesion promoter material according to the invention at least partially also as a constituent of the glass component.

Furthermore, it is advantageous to add Fe₂O₃ and/or V₂O₅ each in an amount of up to 3 weight % to the adhesion promoter material.

As a result, a dental ceramic adhesion promoter layer having a thickness of between 5 and 20 μm can thus be produced which has surprising properties with regard to its adhesion effect. For example, in accordance with the regulations in force, an adhesion value of at least 25 MPa (measured for example using the so-called Schwickerath crack initiation test in accordance with EN ISO 9693) is considered to be sufficient; however, the layers produced within the context of the present invention often exhibit adhesion values of around 80 MPa or above.

As a result, therefore, the invention has shown that the introduction of relatively high proportions of boron trioxide and metal oxide in the form of titanium dioxide and/or tin dioxide into the adhesion promoter material, together with the glass component, not only leads to excellent adhesion of the veneer ceramic to the (preferably precious-metal-free) metal but moreover the adhesion promoter layer according to the invention is also suitable for binding alloys and ceramics having different thermal expansion coefficients to one another in a secure and durable manner.

Further advantages, features and details of the invention emerge from the following description of preferred examples of embodiments.

For example, Table 1 shows one preferred embodiment of the invention; highly favorable properties are obtained if the amount of titanium dioxide used is between approximately 20 and 40% by weight and the amount of tin dioxide used is between approximately 10 and 30% by weight. Within the context of the present invention, the last four components are constituents of a glass component.

TABLE 1

| Component | % by weight |
|---|---|
| B₂O₃ | 2-30 |
| MeO₂ (Me = Ti, Sn) | 10-50 |
| SiO₂ | 10-55 |
| Al₂O₃ | 1-10 |
| (Na/K)₂O | 1-20 |
| CaO | 0-4 |

One variant of the invention is shown in Table 2, wherein an even greater adhesion force could be detected in respect of non-precious metal alloys.

TABLE 2

| Component | % by weight |
|---|---|
| B₂O₃ | 5-20 |
| MeO₂ (Me = Ti, Sn) | 20-40 |
| SiO₂ | 20-50 |
| Al₂O₃ | 2-7 |
| (Na/K)₂O | 5-15 |
| CaO | 0-3 |

Hereinafter, a description will be given of how a dental ceramic adhesion promoter is prepared using the recipes shown in Tables 1 and 2, and it will be demonstrated, on the basis of specific examples, that these products exhibit excellent adhesion properties.

In Example 1, an adhesion promoter comprising a relatively high glass fraction is prepared in accordance with Table 3 below, wherein the components of this recipe are melted and/or sintered at temperatures of 750° C. to 1450° C. and, after cooling, are ground to particle sizes of 30 μm or less. The materials were then applied thinly as an aqueous or alcoholic slip to a precious-metal-free base structure and fired at the temperatures recommended by the alloy manufacturer.

TABLE 3

| Component | % by weight | Adhesion (MPa): |
|---|---|---|
| B₂O₃ | 2.5 | 81.3 |
| TiO₂ | 20 | |
| SiO₂ | 49.7 | |
| Al₂O₃ | 6.0 | Optical finding |
| K₂O | 11.1 | negative |
| Na₂O | 7.3 | |
| CaO | 3.3 | |

The adhesion force was tested in accordance with the standard (EN ISO 9693:2000). Bars of an alloy, e.g. “Remanium 2001” from the company Dentaurum, which were dimensioned in accordance with the standard, were coated in a thin layer (<20 μm) of the materials mixed with water over a length of 8 mm, and then fired at a temperature of 950-990° C. Thereafter, the fired adhesion promoter was veneered twice with Initial PC paste opaquer from the company GC, fired with GC Initial MC Dentin and finished with a subsequent glaze firing. The overall thickness of the coating was 1.1 mm, in accordance with the standard.

The strength of the metal/ceramic bond was tested in accordance with the Schwickerath crack initiation test on a Zwick universal test machine BZ010/TN2S. The fractured surfaces were additionally subjected to an optical check, wherein the presence of ceramic residues on the fractured metal surface was assessed as a positive optical finding.

It was accordingly found that, using the recipe of Example 1, an extremely high adhesion of 81.3 MPa could be achieved, with a negative optical finding.

The following Table 4 varies the example of Table 3 with regard to an adhesion promoter comprising a relatively low glass fraction. Once again, the procedure was carried out as described above, with the right-hand column of Table 4 showing the result. In this case, too, a very high adhesion effect of 79 MPa was found; ceramic residues remain on the fractured metal surface.

TABLE 4

| Component | % by weight | Adhesion (MPa): |
|---|---|---|
| B₂O₃ | 29.8 | 79 |
| TiO₂ | 48.5 | |
| SiO₂ | 13.9 | |
| Al₂O₃ | 1.7 | Optical finding |
| K₂O | 3.1 | positive |
| Na₂O | 2.0 | |
| CaO | 0.9 | |

Finally, as a third example, Table 5 shows an adhesion promoter comprising an average glass fraction, with the procedure being as above. Virtually comparable results as in the second example of Table 4 are obtained here.

TABLE 5

| Component | % by weight | Adhesion (MPa): |
|---|---|---|
| B₂O₃ | 10 | 79 |
| TiO₂ | 50 | |
| SiO₂ | 24.8 | |
| Al₂O₃ | 3.1 | Optical finding |
| K₂O | 5.6 | positive |
| Na₂O | 3.7 | |
| CaO | 1.7 | |

1. A dental ceramic adhesion comprising:
(a) between 10 and 50% by weight of a metal dioxide;
(b) between 3 and 30% by weight of boron trioxide; and
(c) a glass component.

2. The adhesion promoter as claimed in claim 1, wherein the glass component comprises between 5 and 20% by weight of Al₂O₃.

3. The adhesion promoter as claimed in claim 1, wherein the glass component comprises at least one of K₂O and Na₂O in each case in an amount up to 20% by weight.

4. The adhesion promoter as claimed in claim 1, wherein the glass component comprises CaO in an amount up to 5% by weight.

5. The adhesion promoter as claimed in claim 1, wherein the glass component comprises SiO₂.

6. The adhesion promoter as claimed in claim 1, wherein the adhesion promoter material comprises at least one of Fe₂O₃ and V₂O₅ in each case in an amount up to 3% by weight.

7. The adhesion promoter as claimed in claim 1, wherein the metal dioxide is selected from the group consisting of titanium dioxide, tin dioxide and mixtures thereof.

8. A dental restoration consisting of a metal base structure (2) formed of a non-precious metal alloy, the adhesion promoter according to claim 1 and an opaquer layer of a veneer ceramic (3), wherein the adhesion promoter bonds the ceramic to the metal base.

9. The dental restoration as claimed in claim 8, wherein the adhesion promoter forms a binding layer having a thickness of between 5 and 20 μm.

10. A method of producing a dental prosthesis, comprising:
(a) preparing a slip of the adhesion promoter material as claimed in claim 1;
(b) applying the slip to a metal base structure formed of a non-precious metal alloy;
(c) firing the applied slip at a predefined firing temperature to produce a fired coating; and
(d) applying at least one further dental ceramic layer to the fired coating.

11. The method as claimed in claim 10, wherein the firing temperature is between 950° C. and 1000° C.

12. The method as claimed in claim 9, wherein the slip is prepared by melting and/or sintering the adhesion promoter material, cooling and thereafter grinding to a particle size of ≦30 μm.
